(19) United States
(12) Patent Application Publication
(10) Pub. No.: US 2026/0236148 A1
(43) Pub. Date: Aug. 13, 2026

(54) DOCUMENT PRESENTATION METHOD

(71) Applicant: Tencent Technology (Shenzhen) Company Limited, Shenzhen (CN)

(72) Inventor: Huihui DI, Shenzhen (CN)

(73) Assignee: Tencent Technology (Shenzhen) Company Limited, Shenzhen (CN)

(21) Appl. No.: 19/632,106

(22) Filed: Mar. 27, 2026

Related U.S. Application Data
(63) Continuation of application No. PCT/CN2024/114808, filed on Aug. 27, 2024.

(30) Foreign Application Priority Data
Nov. 24, 2023 (CN) 202311592381.2

(51) Int. Cl. G06F 3/0484; G06F 3/0483; G06F 21/62

(52) U.S. Cl. CPC G06F 3/0484; G06F 3/0483; G06F 21/6218

(57) ABSTRACT

In a document presentation method, access information of a remote presentation room corresponding to a presentation of a target document is generated and transmitted to a second terminal. The access information enables the second terminal to access the remote presentation room, from which the presentation of the target document in a room interface of the remote presentation room is observable to the second terminal. In the method, a playback interface of the media file is displayed in the room interface. In the method, a playback state of the media file in the playback interface is controlled based on at least one or more playback control operations triggered in association with one or more positions or elements in the room interface irrespective of whether the one or more positions or elements are in the playback interface.

### RELATED APPLICATIONS

The present application is a continuation of International Application No. PCT/CN2024/114808, filed on August 27, 2024, which claims priority to Chinese Patent Application No. 202311592381.2, filed on November 24, 2023. The entire disclosures of the prior applications are hereby incorporated by reference.

### FIELD OF THE TECHNOLOGY

This disclosure relates to the field of mobile Internet technologies, including a document presentation method and apparatus, an electronic device, a storage medium, and a program product.

### BACKGROUND OF THE DISCLOSURE

With the development of mobile Internet technologies, a presenter may share presentation content with an audience at a different location by using a remote presentation technology. This convenience makes remote presentation applications increasingly favored by users. In some applications, when a to-be-presented document is a web-end online document and includes an audio/video file, synchronization of an audio/video playback state in a remote presentation scenario may be an issue.

In some applications, synchronization of an audio/video playback state in a remote presentation scenario may be implemented through an online document client. For example, a presenter or an audience first downloads and installs an online document client (that is, application software) on a local terminal, and then the presenter creates or imports a to-be-presented document through the client installed on the terminal, and shares a presentation screen of the to-be-presented document with an audience end in a screen sharing mode, thereby implementing synchronization of the presentation screen between a presentation end and the audience end. However, in this mode, both a presenter terminal and an audience end need to download and install a corresponding client, resulting in insufficient convenience in remote presentation or viewing of a document.

### SUMMARY

Embodiments of this disclosure provide a document presentation method and apparatus, an electronic device, a computer-readable storage medium, and a computer program product, through which playback states of a media file can be synchronized between a presenter and an audience through a browser without downloading a remote presentation client, thereby improving convenience of remote presentation.

Embodiments of this disclosure provide a document presentation method. In the method, a document presentation interface of a document presentation application is displayed on a display of a first terminal based on accessing an application webpage link of the document presentation application. In the method, a target document is determined based on a selection operation on the document presentation interface, the target document including a media file controllable through a media control mechanism. In the method, access information of a remote presentation room of the document presentation application corresponding to a presentation of the target document is generated based on a remote presentation operation for the target document. In the method, the access information is transmitted to a second terminal corresponding to a target audience of the presentation, the access information enabling the second terminal to access the remote presentation room, from which the presentation of the target document in a room interface of the remote presentation room is observable to the second terminal when the presentation is controlled through the room interface of the remote presentation room. In the method, presentation content of the target document is displayed in the room interface of the remote presentation room, and a playback interface of the media file is displayed in the room interface. In the method, a playback state of the media file in the playback interface is controlled through the media control mechanism based on at least one or more playback control operations triggered in association with one or more positions or elements in the room interface irrespective of whether the one or more positions or elements are in the playback interface.

Embodiments of this disclosure provide a document presentation apparatus that includes processing circuitry. The processing circuitry is configured to display, on a display, a document presentation interface of a document presentation application based on access of an application webpage link of the document presentation application. The processing circuitry is configured to determine a target document based on a selection operation on the document presentation interface, the target document including a media file controllable through a media control mechanism. The processing circuitry is configured to generate access information of a remote presentation room of the document presentation application corresponding to a presentation of the target document based on a remote presentation operation for the target document. The processing circuitry is configured to transmit the access information to a terminal corresponding to a target audience of the presentation, the access information enabling the terminal to access the remote presentation room, from which the presentation of the target document in a room interface of the remote presentation room is observable to the terminal when the presentation is controlled through the room interface of the remote presentation room. The processing circuitry is configured to display presentation content of the target document in the room interface of the remote presentation room, and display a playback interface of the media file in the room interface. The processing circuitry is configured to control a playback state of the media file in the playback interface through the media control mechanism based on at least one or more playback control operations triggered in association with one or more positions or elements in the room interface irrespective of whether the one or more positions or elements are in the playback interface.

Embodiments of this disclosure provide a non-transitory computer-readable storage medium storing instructions, which when executed by a processor, cause the processor to perform a document presentation method. In the method, a document presentation interface of a document presentation application is displayed on a display based on accessing an application webpage link of the document presentation application. In the method, a target document is determined based on a selection operation on the document presentation interface, the target document including a media file controllable through a media control mechanism. In the method, access information of a remote presentation room of the document presentation application corresponding to a presentation of the target document is generated based on a remote presentation operation for the target document. In the method, the access information is transmitted to a terminal corresponding to a target audience of the presentation, the access information enabling the terminal to access the remote presentation room, from which the presentation of the target document in a room interface of the remote presentation room is observable to the terminal when the presentation is controlled through the room interface of the remote presentation room. In the method, presentation content of the target document is displayed in the room interface of the remote presentation room, and a playback interface of the media file is displayed in the room interface. In the method, a playback state of the media file in the playback interface is controlled through the media control mechanism based on at least one or more playback control operations triggered in association with one or more positions or elements in the room interface irrespective of whether the one or more positions or elements are in the playback interface.

Embodiments of this disclosure provide a document presentation method, applied to a first terminal, the method including: displaying a document presentation interface of a document presentation application in response to an access operation for an application webpage link of the document presentation application; displaying a target document associated with a media file in the document presentation interface, the media file having a media control mechanism preset for controlling a playback state of the media file; generating and displaying access information of a remote presentation room corresponding to the target document in response to a remote presentation operation for the target document; and transmitting the access information to a second terminal corresponding to a target audience, to cause the second terminal to synchronize, after the second terminal accesses the remote presentation room based on the access information, the playback state of the media file when the first terminal controls the playback state of the media file based on the media control mechanism.

Embodiments of this disclosure provide a document presentation apparatus, applied to a first terminal, the apparatus including: a first display module, configured to display a document presentation interface of a document presentation application in response to an access operation for an application webpage link of the document presentation application; a second display module, configured to display a target document associated with a media file in the document presentation interface, the media file having a media control mechanism preset for controlling a playback state of the media file; a third display module, configured to generate and display access information of a remote presentation room corresponding to the target document in response to a remote presentation operation for the target document; and an information transmitting module, configured to transmit the access information to a second terminal corresponding to a target audience, to cause the second terminal to synchronize, after the second terminal accesses the remote presentation room based on the access information, the playback state of the media file when the first terminal controls the playback state of the media file based on the media control mechanism.

Embodiments of this disclosure provide an electronic device, including: a memory (e.g., a non-transitory computer-readable storage medium), configured to store computer-executable instructions or a computer program; and processing circuitry (e.g., a processor), configured to implement, when executing the computer-executable instructions or the computer program stored in the memory, the document presentation method provided in the embodiments of this disclosure.

Embodiments of this disclosure provide a non-transitory computer-readable storage medium, having computer-executable instructions or a computer program stored therein, the computer-executable instructions or the computer program, when executed by processing circuitry (e.g., a processor), implementing the document presentation method provided in the embodiments of this disclosure.

Embodiments of this disclosure provide a computer program product, including a computer program or computer-executable instructions, the computer program or the computer-executable instructions, when executed by processing circuitry (e.g., a processor), implementing the document presentation method provided in the embodiments of this disclosure.

Embodiments of this disclosure may have the following beneficial effects.

Based on one or more embodiments of this disclosure, when performing a remote presentation operation on a target document by accessing an application webpage link (e.g., through a browser) corresponding to a document presentation application, a presentation end (e.g., a first terminal) generates access information of a remote presentation room corresponding to the target document and transmits the access information to a second terminal (e.g., an audience end) corresponding to a target audience, to cause the second terminal to synchronize, after the second terminal accesses the remote presentation room based on the access information, a playback state of a media file when the first terminal controls the playback state of the media file based on a media control mechanism. In this way, the presentation end or the audience end can implement, when the media file in the target document is presented in a remote presentation scenario, synchronization between playback states of the media file at the presentation end and the audience end by accessing the application webpage link corresponding to the document presentation application (that is, accessing the webpage link corresponding to the document presentation application through the browser) without downloading an online document client, thereby improving convenience of remote presentation.

### BRIEF DESCRIPTION OF THE DRAWINGS

FIG. 1 is a schematic architectural diagram of a document presentation system 100 according to an embodiment of this disclosure.

FIG. 2 is a schematic structural diagram of an electronic device 500 according to an embodiment of this disclosure.

FIG. 3 is a schematic flowchart of a document presentation method according to an embodiment of this disclosure.

FIG. 4 is a schematic diagram of display of a document presentation interface according to an embodiment of this disclosure.

FIG. 5 is a schematic diagram of presentation of a target document according to an embodiment of this disclosure.

FIG. 6 is a schematic diagram of triggering of a state control instruction according to an embodiment of this disclosure.

FIG. 7 is a schematic diagram of web-end online document presentation according to an embodiment of this disclosure.

FIG. 8 is a schematic flowchart of a document presentation method according to an embodiment of this disclosure.

FIG. 9 is a schematic diagram of remote presentation according to an embodiment of this disclosure.

### DESCRIPTION OF EMBODIMENTS

To describe one or more of the objectives, technical solutions, and advantages of this disclosure, the following describes examples of this disclosure in further detail with reference to the accompanying drawings. The described embodiments are not to be considered as a limitation to this disclosure. Other embodiments may fall within the scope of this disclosure.

In the following descriptions, the term "some embodiments" describes subsets of all possible embodiments, but "some embodiments" may be the same subset or different subsets of all the possible embodiments, and can be combined with each other without conflict.

In the following descriptions, the included term "first/second" is merely intended to distinguish similar objects but does not necessarily indicate a specific order of an object. "First/second" is interchangeable in terms of a specific order or sequence if permitted, so that the embodiments of this disclosure described herein can be implemented in an order in addition to the order shown or described herein.

In the embodiment of this disclosure, the term "module" or "unit" refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules or units. In addition, each module or unit may be a part of an overall module or unit including a function of the module or unit.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Unless otherwise defined, all technical and scientific terms used herein have the same meanings as commonly understood by a person skilled in the art to which the present disclosure belongs. Terms used in this specification are merely intended to describe embodiments of this disclosure, and are not intended to limit this disclosure.

Before embodiments of this disclosure are further described in detail, some nouns and terms included in embodiments of this disclosure are described, and the following explanations are applicable to the nouns and terms included in embodiments of this disclosure. Descriptions of terms in this disclosure are provided as examples and are not intended to limit the scope of the disclosure.

1) Remote presentation: Remote presentation may correspond to a scenario where a presenter shares presentation content with an audience at a different location through, for example, a browser.

2) Remote presentation room layer: A remote presentation room layer may correspond to an architecture layer configured to manage and coordinate connections and communication among a plurality of participants (e.g., including a presenter and an audience) in a remote presentation scenario. The plurality of participants may be located at different geographic locations, and the room layer may be responsible for managing a connection between participants and synchronizing presentation content and a presentation state.

3) Web application: A web application may correspond to a software application that is run through an Internet browser and that performs data transmission and logical processing by relying on a web server. In some examples, the web application is an application accessed and run through a web browser, through which a user can use a corresponding function by only accessing a specific website through a browser without locally installing additional software or an additional client.

4) WebSocket: WebSocket is a protocol for implementing bidirectional communication in a web application, and may provide a persistent connection mode to allow real-time bidirectional data transmission between a server and a terminal.

5) eXtensible Markup Language (XML): XML may correspond to a markup language configured to describe data, and may use tags to identify a structure and content of data. Document content of a presentation document may be stored in an XML file. The presentation document includes, but is not limited to, a document in the following formats: a slide or Microsoft PowerPoint (PPT), a Portable Document Format (PDF), and a Microsoft word format.

6) JSON: JSON may correspond to a lightweight data exchange format, usually configured for data transmission and storage between different applications.

7) "In response to": "In response to" may correspond to indicating a condition or state on which one or more to-be-performed operations depend. In a case that the condition or state is satisfied, the one or more operations may be performed in real time or after a set delay. Unless otherwise specified, there is no restriction on an order in which a plurality of operations are performed.

In this disclosure, two events occurs “in real time” or “in a synchronized manner” or “synchronization of two events” may refer to the two events occurring with only immaterial delays in processing and/or communication.

The embodiments of this disclosure provide a document presentation method and apparatus, an electronic device, a non-transitory computer-readable storage medium, and a computer program product, through which playback states of a media file can be synchronized between a presenter and an audience. Embodiments of the electronic device in this disclosure are described below. The electronic device provided in the embodiments of this disclosure may be implemented as various types of terminals such as a notebook computer, a tablet computer, a desktop computer, a set-top box, a mobile device (such as a mobile phone, a portable music player, a personal digital assistant, a dedicated messaging device, or a portable gaming device), a smartphone, a smart speaker, a smartwatch, a smart TV, an augmented reality (AR) device, and a virtual reality (VR) device, or may be implemented as a server, where the server may be an independent physical server, or may be a server cluster or a distributed system including a plurality of physical servers, or may be a server cluster that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. In a non-limiting example, the terminal and the server may be directly or indirectly connected in a wired or wireless communication manner.

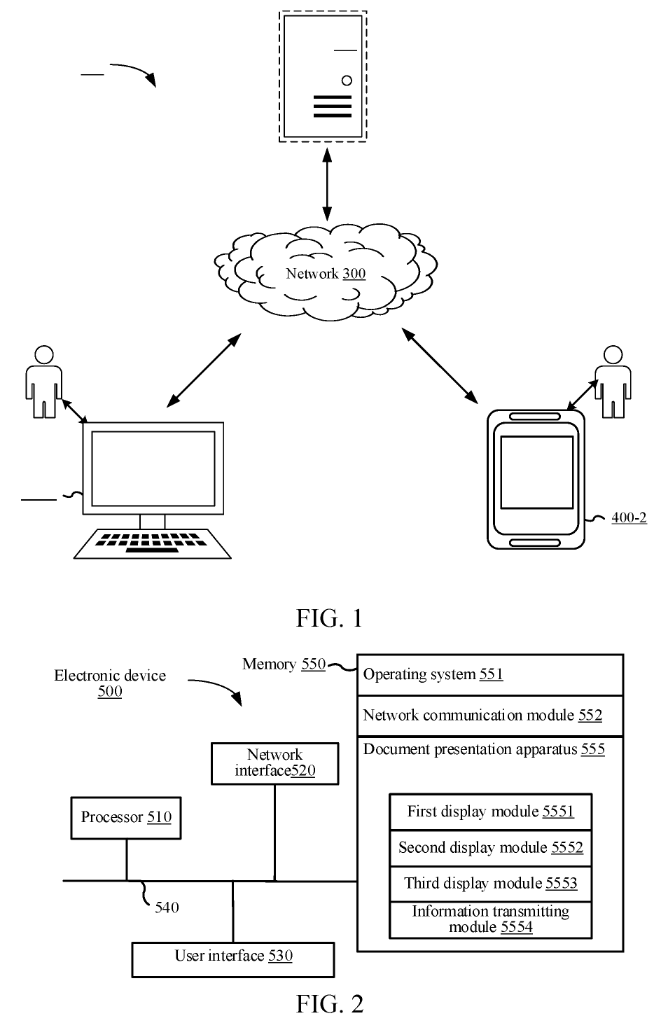

FIG. 1 is a schematic architectural diagram of a document presentation system 100 for a social network according to an embodiment of this disclosure. In some examples, terminals (for example, a first terminal 400-1 and a second terminal 400-2 are shown) are connected to a server 200 by a network 300. The network 300 may be a wide area network, a local area network, or a combination of the two.

Using an example in which the first terminal 400-1is a terminal on a presenter side, and the second terminal 400-2 is a terminal on an audience side, when a presenter accesses an application webpage link of a document presentation application through the first terminal 400-1, the first terminal 400-1 displays a document presentation interface of the document presentation application in response to an access operation; displays a target document associated with a media file in the document presentation interface, the media file having a media control mechanism preset for controlling a playback state of the media file; and transmits a remote presentation request for the target document to the server 200 in response to a remote presentation operation for the target document. The server 200generates access information of a remote presentation room (such as a room webpage link or a graphic barcode corresponding to the remote presentation room) corresponding to the target document based on the remote presentation request, and returns the access information to the first terminal 400-1 for display. The first terminal 400-1 transmits the access information to a second terminal 400-2 corresponding to a target audience, to cause the second terminal 400-2 to synchronize, after the second terminal 400-2 accesses the remote presentation room based on the access information, the playback state of the media file when the first terminal 400-1controls the playback state of the media file based on the media control mechanism.

FIG. 2 is a schematic structural diagram of an electronic device 500 according to an embodiment of this disclosure. Using an example in which the electronic device 500 is the first terminal 400-1 in FIG. 1, the electronic device 500 shown in FIG. 2 includes processing circuitry (e.g., at least one processor 510), a memory 550, at least one network interface 520, and a user interface 530. All components in the electronic device 500 are coupled together by a bus system 540. The bus system 540 is configured to implement connections and communication between the components. In addition to a data bus, the bus system 540 further includes a power bus, a control bus, and a state signal bus. However, for clarity of description, all types of buses in FIG. 2 are marked as the bus system 540.

The processor 510 may be an integrated circuit chip having a signal processing capability, for example, a general-purpose processor, a DSP, or another PLD, discrete gate, transistor logical device, or discrete hardware component. The general-purpose processor may be a microprocessor, any suitable processor, or the like.

The memory 550 includes a volatile memory or a non-volatile memory, or may include a volatile memory and a non-volatile memory. The non-volatile memory may be a read-only memory (ROM). The volatile memory may be a random-access memory (RAM). The memory 550 described in the embodiments of this disclosure is to include any other suitable types of memories. The memory 550, in an embodiment, includes one or more storage devices physically away from the processor 510. In some embodiments, the memory 550 includes a non-transitory computer-readable storage medium configured to store instructions, which when executed by processing circuitry such as the processor 510, cause the processor to perform a document presentation method as described in this disclosure.

In some embodiments, the memory 550 may store data to support various operations. Examples of the data include a program, a module, and a data structure or other subsets or supersets, which are exemplified below.

An operating system 551 includes system programs for processing various basic system services and performing hardware-related tasks, such as a framework layer, a kernel library layer, and a drive layer, and is configured to implement various basic services and process hardware-based tasks. A network communication module 552 is configured to reach another electronic device through one or more (wired or wireless) network interfaces 520. In some examples, network interfaces 520 include one or more of Bluetooth, Wi-Fi, a universal serial bus (USB), or the like.

In some embodiments, the document presentation apparatus provided in the embodiments of this disclosure may be implemented by software. The document presentation apparatus provided in the embodiments of this disclosure may be provided as various software embodiments, including various forms such as an application, software, a software module, a script, or code. FIG. 2 shows a document presentation apparatus 555 stored in the memory 550, which may be software in a form a program and a plug-in, and include a series of modules, including: a first display module 5551, a second display module 5552, a third display module 5553, and an information transmitting module 5554. These modules are logical and may be combined or split in different manners depending on functions implemented, and functions of the modules are described below.

In some other embodiments, the apparatus provided in the embodiments of this disclosure may be implemented by hardware. For example, the apparatus provided in embodiments of this disclosure may be a processor in a form of a hardware decoding processor, programmed to perform the document presentation method provided in the embodiments of this disclosure. For example, the processor in the form of the hardware decoding processor may be one or more application-specific integrated circuits (ASIC), a digital signal processor (DSP), a programmable logic device (PLD), a complex programmable logic device (CPLD), a field-programmable gate array (FPGA), or other electronic components.

In some embodiments, the terminal or the server may implement the document presentation method provided in the embodiments of this disclosure by running various computer-executable instructions or a computer program. For example, the computer-executable instructions may be microprogram-level commands, machine instructions, or software instructions. The computer program may be a native program or a software module in an operating system, or may be a mini program that can be embedded into any local application, that is, a program that only needs to be downloaded into a browser environment for running. To sum up, the computer-executable instructions may be instructions in any form, and the foregoing computer program may be an application, a module, or a plug-in in any form.

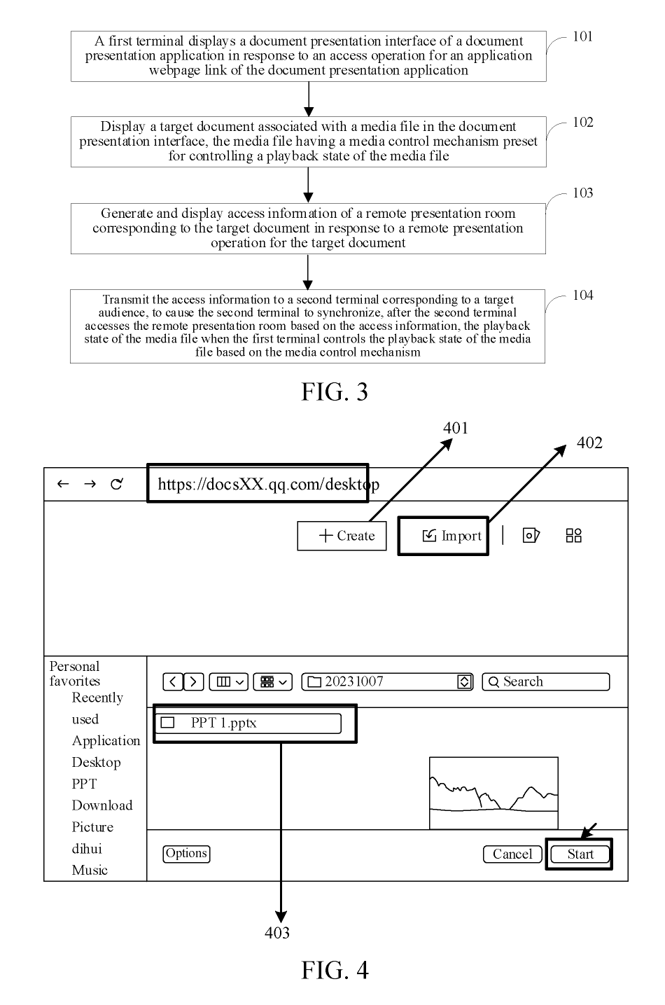

As stated above, the document presentation method provided by the embodiments of this disclosure may be performed by different types of electronic devices, for example, may be independently performed by the terminal in FIG. 1, or may be jointly performed by the terminal and the server 200 in FIG. 1. Description is provided below by using an example in which the terminal (for example, the first terminal 400-1 on the presenter side) in FIG. 1 independently performs the document presentation method provided by the embodiments of this disclosure. FIG. 3 is a schematic flowchart of a document presentation method according to an embodiment of this disclosure. Description is provided with reference to the operations shown in FIG. 3.

Operation 101: A first terminal displays a document presentation interface of a document presentation application in response to an access operation for an application webpage link of the document presentation application. For example, a document presentation interface of a document presentation application is displayed on a display of a first terminal based on accessing an application webpage link of the document presentation application.

The application webpage link is a network address corresponding to the document presentation application, and may be a hyperlink stored in the first terminal. When a presenter accesses the application webpage link, for example, clicks/taps the hyperlink or copies and pastes the application webpage link into a search engine (that is, a browser), the first terminal displays the document presentation interface of the document presentation application in response to the access operation, that is, enters the document presentation interface (or a document presentation room) through the browser.

Operation 102: Display a target document associated with a media file in the document presentation interface, the media file having a media control mechanism preset for controlling a playback state of the media file. In some examples, a target document is determined based on a selection operation on the document presentation interface, the target document including a media file controllable through a media control mechanism.

In some embodiments, the first terminal may display the target document associated with the media file in the document presentation interface in the following manner: displaying a document import control in the document presentation interface; and displaying, in response to a document import operation triggered based on the document import control, the imported target document associated with the media file.

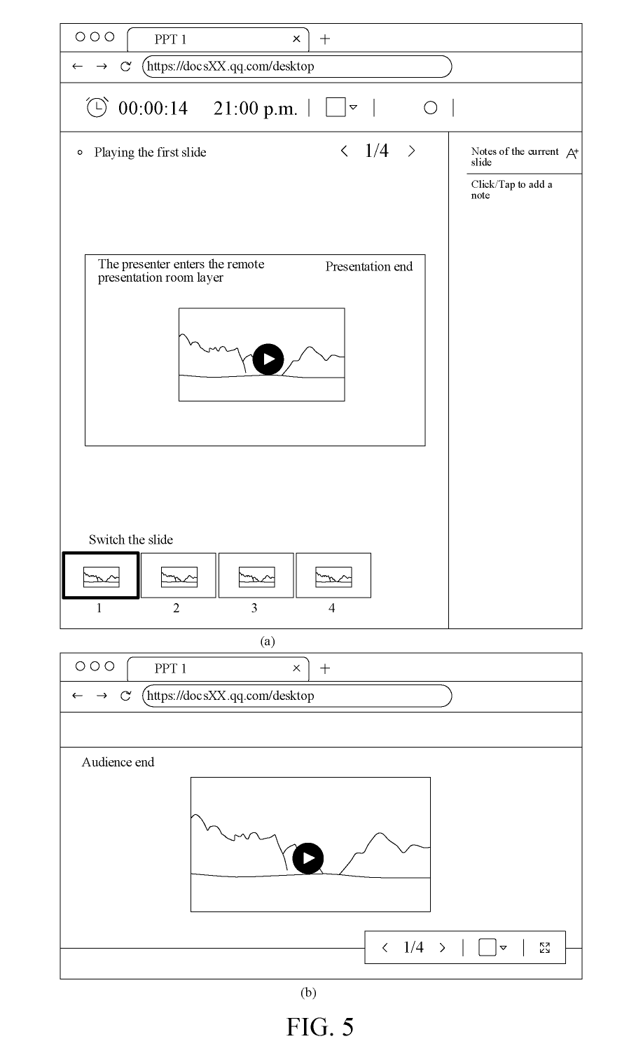

In some examples, the presenter may create a to-be-presented target document in the document presentation interface, or may import, through the document import control, a target document for presentation. FIG. 4 is a schematic diagram of display of a document presentation interface according to an embodiment of this disclosure. When the presenter accesses, in the first terminal, the application webpage link, for example, "https://docs.xx.com/", corresponding to the document presentation application, in response to the access operation, the first terminal displays the document presentation interface corresponding to the document presentation application, and displays a creation entrance 401 and a document import control 402 in the document presentation interface. A target document may be created as a to-be-presented document through the creation entrance 401. An existing target document may be imported as a to-be-presented document through the document import control 402. For example, at least one candidate document for import is displayed in response to a trigger operation for the document import control 402, and in response to a selection operation for a target document (such as PPT 1.pptx) 403 in the at least one candidate document, the imported target document 403 is displayed in the document presentation interface.

The target document includes, but is not limited to, a document in the following formats: PPT, PDF, and word. A media file is pre-associated with the target document. A presentation form of the media file includes at least one of the following: an audio file and a video file. A media control mechanism may be preset for the media file. The media control mechanism is configured for controlling a playback state of the media file, for example, controlling a playback state, such as playback started, playback stopped, playback fast-forwarded, or playback rewound, of the media file. That is, the media control mechanism indicates an implementation method for playing the media file in a corresponding playback state. The media control mechanism includes, but is not limited to, a position-triggered mechanism and an element-triggered mechanism. The position-triggered mechanism instructs to trigger a corresponding position in the document presentation interface to control a change of the playback state of the media file. The element-triggered mechanism instructs to trigger a corresponding element in the document presentation interface to control a change of the playback state of the media file, for example, control the media file to change from a playback paused state (not playing) to a playback started state (playing), or change from a playback started state (playing) to a playback stopped state (not playing). A trigger position indicated by the position-triggered mechanism or a trigger element indicated by the element-triggered mechanism may be set in different manners in the document presentation interface according to an actual requirement.

Operation 103: Generate and display access information of a remote presentation room corresponding to the target document in response to a remote presentation operation for the target document. For example, access information of a remote presentation room of the document presentation application corresponding to a presentation of the target document is generated based on a remote presentation operation for the target document.

In some embodiments, the first terminal may generate and display the access information of the remote presentation room corresponding to the target document in the following manner: obtaining a room identifier of the remote presentation room, and generating a room webpage link corresponding to the remote presentation room based on the room identifier and the application webpage link; and displaying the room webpage link as the access information, or displaying, as the access information, a graphic barcode obtained by encoding the room webpage link.

In some examples, the remote presentation operation may be triggered through a remote presentation entrance. For example, the remote presentation entrance is displayed in the document presentation interface. The first terminal receives, in response to a trigger operation for the remote presentation entrance, a remote presentation operation for the target document, obtains, in response to the remote presentation operation, a room identifier of a remote presentation room (the room identifier and a document identifier of the target document are in a one-to-one correspondence), obtains, based on the room identifier, an application webpage link corresponding to the document presentation application, generates a room webpage link of the remote presentation room (the room webpage link corresponds to the room identifier of the remote presentation room, and the room webpage link is a unique link of the remote presentation room), and directly uses the room webpage link as access information of the remote presentation room, for the audience end to enter the remote presentation room by accessing the room webpage link, to view presentation content of the target document; or after generating the room webpage link of the remote presentation room based on the room identifier and the application webpage link corresponding to the document presentation application, further encodes the room webpage link to obtain a corresponding graphic barcode (which is an encoding mode that can be read through a terminal and includes information that can be understood and interpreted by a terminal machine, for example, a barcode, a matrix barcode, or a two-dimensional barcode), and uses the graphic barcode as access information of the remote presentation room, for the audience end to enter the remote presentation room by scanning the graphic barcode, to view presentation content of the target document.

Operation 104: Transmit the access information to a second terminal corresponding to a target audience, to cause the second terminal to synchronize, after the second terminal accesses the remote presentation room based on the access information, the playback state of the media file when the first terminal controls the playback state of the media file based on the media control mechanism. For example, the access information is transmitted to a second terminal corresponding to a target audience of the presentation. In some examples, the access information enables the second terminal to access the remote presentation room, from which the presentation of the target document in a room interface of the remote presentation room is observable to the second terminal when the presentation is controlled through the room interface of the remote presentation room.

In some examples, the first terminal may conduct and control presentation of the target document in room interface of the remote presentation room. In some examples, presentation content of the target document is displayed in the room interface of the remote presentation room. A playback interface of the media file is displayed in the room interface. A playback state of the media file in the playback interface is controlled through the media control mechanism based on at least one or more playback control operations triggered in association with one or more positions or elements in the room interface irrespective of whether the one or more positions or elements are in the playback interface.

In some embodiments, the first terminal may transmit the access information to the second terminal corresponding to the target audience in the following manner: transmitting the access information to the second terminal corresponding to the target audience in a target mode, the target mode including at least one of the following: an instant messaging mode, an email mode, a short message mode, or a call notification mode.

After generating the access information of the remote presentation room corresponding to the target document, the first terminal can transmit the access information of the remote presentation room to the second terminal corresponding to the target audience in the target mode, for the second terminal to enter the remote presentation room based on the access information of the remote presentation room to view presentation content of the target document. The target mode may be an instant messaging mode, that is, the first terminal transmits, in a form of an instant messaging session message, a session message including the access information of the remote presentation room to the second terminal corresponding to the target audience, so that when the audience triggers the access information in the session message displayed by the second terminal, in response to the trigger operation, the second terminal jumps from a display page of the session message to the remote presentation room that the access information instructs to access, and presents a presentation screen of the target document in the remote presentation room.

The target mode may alternatively be an email mode, that is, the first terminal transmits, in an email mode, an email including the access information of the remote presentation room to the second terminal of the target audience, so that when the audience triggers the access information in the email displayed by the second terminal, in response to the trigger operation, the second terminal jumps from a display page of the email to the remote presentation room that the access information instructs to access, and presents a presentation screen of the target document in the remote presentation room.

The target mode may alternatively be a short message mode, that is, the first terminal transmits, in a short message mode, a short message including the access information of the remote presentation room to the second terminal corresponding to the target audience, so that when the audience triggers the access information in the short message displayed by the second terminal, in response to the trigger operation, the second terminal jumps from a display page of the short message to the remote presentation room that the access information instructs to access, and presents a presentation screen of the target document in the remote presentation room.

In addition, the target mode may alternatively be a call notification mode. For example, the presenter may transmit a notification request carrying the access information of the remote presentation room and a communication number of the target audience to the server through the first terminal. The server transmits a call request for the target audience to a call center in response to the notification request. After receiving the call request, the call center obtains the communication number of the target audience, for example, obtains a mobile phone number of the target audience bound to an instant messaging application and uses the mobile phone number as the communication number of the target audience, and invokes an operator interface corresponding to the communication number to call the communication number. After the target audience answers the call, the operator returns a call state notification (that is, a reply) to the call center, and returns the call state notification of the target audience to the server through the call center. When determining, based on the call state notification, that the target audience is in an answering state, the server transmits a notification voice of the access information for the remote presentation room to the call center. The call center invokes the operator interface to play the notification voice based on the access information, and prompts the target audience to perform a corresponding operation (for example, trigger a target key or say a target statement) corresponding to the access information to enter the remote presentation room. After performing the corresponding operation according to the prompt, the target audience can enter the remote presentation room to view presentation content of the target document. By then, the call notification is completed.

In some embodiments, after transmitting the access information to the second terminal corresponding to the target audience, the first terminal may also display presentation content of the target document in a room interface of the remote presentation room; display, in the process of displaying the presentation content of the target document, a playback interface of the media file in the room interface in response to that a presentation occasion of the media file arrives; and control the playback state of the media file in the playback interface in response to a state control instruction triggered based on the media control mechanism.

FIG. 5 is a schematic diagram of presentation of a target document according to an embodiment of this disclosure. In (a), after a first terminal transmits access information to a second terminal corresponding to a target audience, the first terminal may enter a remote presentation room corresponding to the target document, present a target document in a room interface of the remote presentation room, and display presentation content of the target document in real time in the room interface of the remote presentation room in the process of presenting the target document. Meanwhile, in (b), after the second terminal of the target audience enters the remote presentation room, the presentation content of the target document is displayed in real time in a room interface of the remote presentation room. That is, in the room interfaces of the first terminal and the second terminal that enter the same remote presentation room, presentation content displayed at a same moment is always the same.

When a presentation occasion of a media file associated with a target document arrives, the first terminal displays a playback interface of the media file in the room interface. Because the media file is associated with a media control mechanism, a playback state of the media file in the playback interface may be controlled through a state control instruction triggered based on the media control mechanism, for example, the media file is controlled to change from a playback paused state (not playing) to a playback started state (playing), or from a playback started state (playing) to a playback stopped state (not playing), and at the same time, the second terminal of the target audience viewing the presentation content of the target document in the remote presentation room synchronize the playback state of the media file when the first terminal controls the playback state of the media file based on the media control mechanism. That is, playback states of the media file corresponding to a same moment are consistent in the playback interfaces of the room interfaces of the first terminal and the second terminal. For example, when the first terminal controls the media file to start playing in the playback interface, the media file in the playback interface of the second terminal also starts playing. For another example, when the first terminal controls the media file to stop playing in the playback interface, the media file in the playback interface of the second terminal also stops playing. In this way, the presentation end (that is, the first terminal) or the audience end (that is, the second terminal) can implement, when the media file in the target document is presented in a remote presentation scenario, synchronization between playback states of the media file at the presentation end and the audience end by accessing the application webpage link corresponding to the document presentation application (that is, accessing the webpage link corresponding to the document presentation application through the browser) without downloading an online document client, thereby improving convenience of remote presentation.

In some embodiments, before displaying the playback interface of the media file in the room interface, the first terminal may determine, in the following manner, that the presentation occasion of the media file arrives: determining, in response to presenting a target page of the media file in the target document and presentation duration of the target page reaches target duration, that the presentation occasion of the media file arrives; or displaying, in response to presenting a target page of the media file in the target document, a presentation control (e.g., a presentation control element) of the media file in the target page, and determining, in response to a trigger operation for the presentation control, that the presentation occasion of the media file arrives; or displaying, in response to presenting a target page of the media file in the target document, presentation prompt information corresponding to the media file at a display position associated with the media file in the target page, and determining, in response to a determining operation for the presentation prompt information, that the presentation occasion of the media file arrives.

In some examples, before presenting the target document, the presenter may arrange and configure composing parts and a page quantity (that is, a page number) of the target document, for example, place the media file at which position in which page of the target document in an associated manner, and may preset a presentation occasion of the media file (that is, a playback condition of the media file), that is, preset a condition under which display of a playback interface of the media file can be triggered.

During actual implementation, when the target document corresponds to a plurality of pages (for example, when the target document is in a PPT format, the presentation page may include a plurality of slides, and when the target document is in a Word format, the presentation page may include a plurality of document pages), it may be preset that when presentation duration of presenting a target page of the media file in the target document reaches target duration (that is, when the presenter presents the target page of the media file to the N^{th} second, where N is the target duration and may be set according to an actual requirement, for example, set to three seconds), it is determined that a presentation occasion of the media file arrives, so that the playback interface of the media file is displayed on the room interface. In this way, when the presentation duration of the target page (that is, display duration of the target page) reaches preset target duration, display of the playback interface of the media file can be automatically triggered without requiring the presenter to perform any operation, thereby improving intelligence of the presentation process, and further improving document presentation efficiency.

In addition, it may be preset that when a target page of the media file in the target document is presented, a presentation control of the media file is displayed in the target page, or presentation prompt information corresponding to the media file is displayed at a display position associated with the media file in the target page, and in a manner of triggering the presentation control or performing a determining operation for the presentation prompt information, it is determined that a presentation occasion of the media file arrives, so that the playback interface of the media file is displayed on the room interface. In this way, display of the playback interface of the media file is triggered by the presenter actively performing a trigger operation or a determining operation, thereby improving flexibility and applicability of the presentation process.

In some embodiments, the first terminal may display the playback interface of the media file in the room interface in the following manner: displaying the playback interface of the media file through a sub-interface independent of the room interface; or presenting, in a target animation presentation mode, a process in which the playback interface of the media file moves to a target region of the room interface.

When the playback interface of the media file is displayed, the playback interface of the media file may be displayed through a sub-interface independent of the room interface (that is, the sub-interface independent of the room interface is used as the playback interface of the media file). In this case, the presenter can freely drag the playback interface (or sub-interface) to change a position of the playback interface (or sub-interface) in the room interface. When the playback interface of the media file is displayed, a process in which the playback interface of the media file moves to a target region of the room interface may also be presented in a target animation presentation mode. For example, a process in which the playback interface moves from an edge region of the room interface to a middle region of the room interface is dynamically presented.

In some embodiments, the first terminal may control, in response to the state control instruction that is triggered based on the media control mechanism, the playback state of the media file in the playback interface in the following manner: controlling, when the media control mechanism is a position-triggered mechanism, in response to a first state control instruction triggered based on a first position, the media file to start playing in the playback interface; and controlling, in a process of playing the media file in the playback interface, in response to a second state control instruction triggered based on a second position, the media file to stop playing in the playback interface, the playback interface being a sub-interface of the room interface, and the first position and the second position each including at least one of the following positions: any position in another sub-interface in the room interface other than the playback interface and any position in the playback interface.

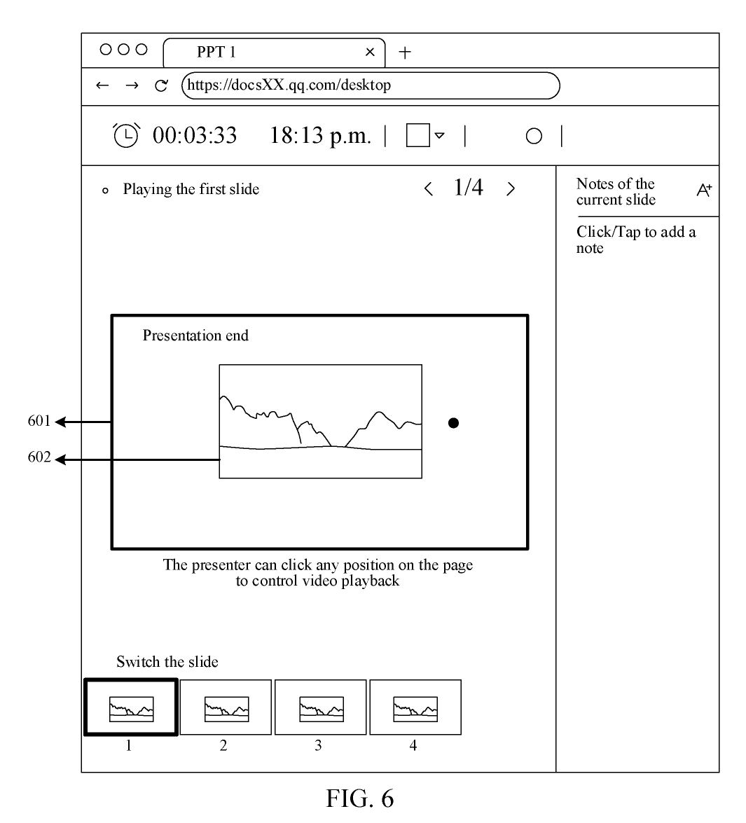

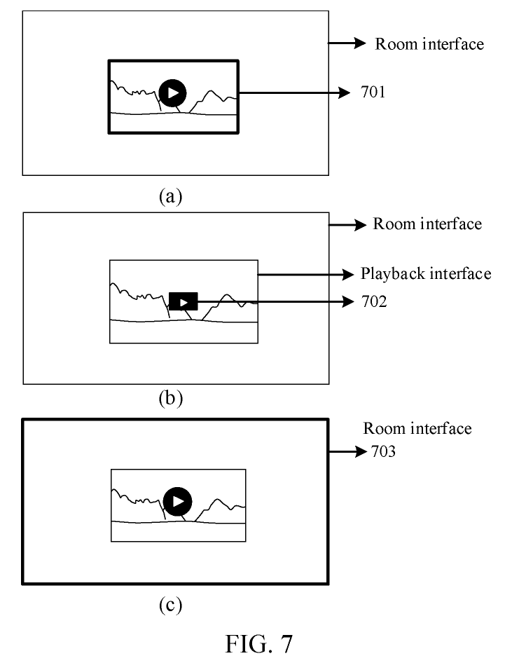

FIG. 6 is a schematic diagram of triggering of a state control instruction according to an embodiment of this disclosure. When the media control mechanism is a position-triggered mechanism, a playback state of a media file may be changed by triggering any position in a room interface 601. For example, when the presenter triggers a first position, in response to a first state control instruction triggered based on the first position (which may be any position in the room interface 601), the first terminal controls the media file to start playing in a playback interface 602, that is, controls the playback state of the media file to change from not playing to playing. During playback of the media file, the presenter triggers a second state control instruction by triggering a second position (which may be any position in the room interface 601), to control the media file to stop playing in the playback interface 602, that is, changes the playback state of the media file from playing to not playing. The first position and the second position may be the same or may be different. Neither of the first position and the second position is limited to any position in the playback interface 602 corresponding to the media file, and the first position and the second position may also be any positions in another interface in the room interface 601 other than the playback interface 602.

In the foregoing manner, in a remote presentation scenario, when a media file is presented, the presenter can freely control playback and pause of the media file by triggering any position in the room interface of the remote presentation room, thereby expanding an interactive control region of the media file to make user operations more convenient, and further improving remote presentation experience.

In some embodiments, the first terminal may accelerate a playback progress of the media file in response to a trigger operation for a fast forward control (e.g., a fast forward control element) in the playback interface in the process of playing the media file in the playback interface; and rewind a playback progress of the media file in response to a trigger operation for a rewind control (e.g., a rewind control element) in the playback interface.

In some examples, because the playback interface of the media file has a control (for example, a playback control, a fast forward control, or a rewind control) configured to control a playback state of the media file, when the first position or the second position is any position in the playback interface, the first position or the second position may be a position of the control, or may be a position in another region in the playback interface other than the control. The playback progress of the media file may be accelerated through the fast forward control, and the playback progress of the media file may be rewound through the rewind control. In this way, a related control that the playback interface of the media file itself has is inherited or migrated to the remote presentation application, and by displaying the related control that the playback interface of the media file itself has in the remote presentation room, the playback progress of the media file is conveniently controlled.

In some embodiments, the first terminal may control, in response to the state control instruction that is triggered based on the media control mechanism, the playback state of the media file in the playback interface in the following manner: obtaining, when the media control mechanism is an element-triggered mechanism, a target trigger element associated with the element-triggered mechanism, the target trigger element being any one or more trigger elements in the room interface; and controlling the playback state of the media file in the playback interface in response to a state control instruction triggered based on the target trigger element.

When the media control mechanism is an element-triggered mechanism, the interactive control region of the media file may further be reduced to any one or more trigger elements in the room interface, and is not limited to a control element that the playback interface of the media file itself has. That is, a target trigger element triggering the media control mechanism may be preset, and the playback state of the media file is controlled by triggering the target trigger element. In this way, a user may preset, according to an actual requirement or a presentation habit of the user, a target trigger element for triggering the media control mechanism, which makes user operations more convenient during document presentation, thereby improving the remote presentation experience.

In some embodiments, the first terminal may continue playing the media file in the following manner: outputting media content of the media file through the playback interface when the playback state indicates that the media file is being played; displaying, in response to a presentation operation for another part in the target document other than the media file, presentation content of the another part in the room interface other than the media file in the process of outputting the media content; and adjusting a parameter of the playback interface in the process of displaying the presentation content of the another part, and continuing outputting the media content through the playback interface corresponding to the adjusted parameter, the parameter including at least one of the following: a size of the playback interface, a position of the playback interface, transparency of the playback interface, and a volume at which audio content is outputted through the playback interface.

In some examples, in the process of playing the media file, the presenter may further present another part in the target document other than the media file (the another part herein may refer to any content in the target document other than the media file). The another part may be other document content in the target page of the media file other than the media file, or may be document content in another page different from the target page of the media file. The presenter may trigger a presentation operation for another part based on, for example, sliding a target page of the media file in a slide manner to trigger the presentation operation for the another part, or turning from a target page of the media file to another page in a page turning manner to trigger the presentation operation for the another part. The page turning manner may be triggered through a page turning control in the playback interface, or may be triggered through an input device such as a keyboard or a mouse, or may be triggered when a timed page turning occasion preset by the presenter arrives, or certainly, may be another triggering manner. The page turning manner is not limited in the embodiments of this disclosure.

In response to the presentation operation for the another part, the first terminal displays presentation content of the another part in the room interface, and while displaying the presentation content of the another part in the room interface, adjusts the playback interface of the media file, for example, adjusts a size of the playback interface of the media file (for example, zooms out the playback interface of the media file), or adjusts a position of the playback interface of the media file in the room interface (for example, adjusts the playback interface of the media file from a middle position in the room interface to an edge position in the room interface); or adjusts transparency of the playback interface of the media file, for example, when the presentation content of the another part is covered by the playback interface of the media file, adjusts the transparency of the playback interface of the media file, to display the presentation content of the another part through the playback interface of the media file; or adjusts a volume at which audio content of the media file is outputted through the playback interface of the media file, for example, reduces a volume output of the media file to reduce interference caused by playing the media file with the presentation content of the another part, or adjusts a presentation volume of the presenter for the another part, for example, increases or reduces the presentation volume of the presenter for the another part, or reduces, when the presentation content of the another part is outputted through audio, an audio output volume of the presentation content of the another part to enhance presentation quality of the media file, or increases an audio output volume of the another part of presentation content while reducing an output volume of the media file to enhance presentation quality of the another part.

In the foregoing manner, playback of the media file and presentation of the another part are independent of each other. The presentation content of the another part is also displayed while playing the media file in the room interface of the same remote presentation room, which satisfies diversified information obtaining requirements of a user, and presentation of different types of information does not interfere with each other, thereby improving the viewing experience.

In some embodiments, the first terminal may present document content of another type in the following manner: when the target document includes target content associated with an animated presentation effect, presenting, in the process of displaying the presentation content of the target document, the target content in a presentation style corresponding to the animated presentation effect in response to that a presentation occasion of the target content arrives.

When the target document is associated with target content having an animated presentation effect, that is, a presentation style of the target content has an animated presentation effect, for example, an animated presentation effect, such as "Fly in", "Fly out", and "Blinds", in PPT presentation, this type of target content may also be referred to as an animation (such as an entrance animation, an exit animation, or an emphasis animation). When a presentation occasion of the target content arrives, the target content can be presented in a presentation style corresponding to the animated presentation effect. For example, an animated presentation effect associated with the target content is "Blinds", and a presentation occasion corresponding to the target content is when the presenter clicks/taps the target content, and the target content is presented in a form of the animated presentation effect "Blinds".

In the foregoing manner, an animation effect associated with the presented target content is inherited or migrated to the remote presentation application, thereby not only enhancing authenticity of document presentation, but also improving diversity and interest of the presentation effects.

In some embodiments, the first terminal may determine, in the following manner, whether the presentation occasions of the media file and the target content arrive: creating, based on the presentation occasion of the media file and the presentation occasion of the target content, a presentation timeline configured for controlling a presentation order of the media file and the target content; and determining, based on the presentation timeline, whether the presentation occasions of the media file and the target content arrive.

When the target document includes both the media file and the target content associated with the animated presentation effect, the presentation timeline configured for controlling a presentation order of the media file and the target content may be created based on the presentation occasion of the media file and the presentation occasion of the target content. That is, the presentation timeline is created according to a chronological order of presentation time points of the media file and the target content. Then, whether the presentation occasions of the media file and the target content arrive is determined based on the presentation order or the presentation time points of the media file and the target content as indicated by the presentation timeline. In addition, when the presentation occasion of the media file arrives, the playback interface of the media file is displayed, to play the media file based on the playback interface. When the presentation occasion of the target content arrives, the target content is presented in a presentation style corresponding to the animated presentation effect associated with the target content. That is, different types of composing parts, such as the media file in the target document and the target content associated with the animated presentation effect, are uniformly managed based on the presentation timeline, thereby enabling that the different types of composing parts may be sequentially presented in an orderly manner according to a corresponding presentation order.

In some embodiments, the first terminal may display the presentation content of the target document in the following manner: controlling, in response to a document presentation operation triggered through a control device, presentation of another part in the target document other than the media file according to a presentation rhythm indicated by the document presentation operation, and synchronously displaying presentation content of the another part, the control device including at least one of the following: a keyboard, a mouse, a remote control, and a virtual keyboard in a presentation extended screen.

In some examples, another part in the target document other than the media file may be presented. For example, when page turning presentation is performed on the another part through a control device, a document presentation operation instructing page turning may be triggered by sliding a mouse or pressing a key (such as a space bar key, a down key, or a forward key) in a keyboard, or using an infrared remote control, or triggering a related key in a virtual keyboard. In addition, the document presentation operation may also be triggered by presenting a virtual keyboard in a presentation extended screen.

The presentation extended screen means that in an application scenario in which a main screen is selected to present the target document (for example, play a PPT) in full screen, and a secondary screen is selected to perform display for the presenter, not only document display can be extended, but also a note can be viewed, which supports a mobile phone or a tablet computer to become a secondary screen (that is, the presentation extended screen) in a wireless manner, and achieves, by simulating a mouse function, an objective of controlling presentation on the main screen by the secondary screen. The presentation extended screen may refer to a process of expanding a display region through an additional display device (such as a projector or a display) when a target document is presented on a first terminal such as a computer or a notebook computer. A presenter needs to set a presentation mode before presentation, for example, before the presentation starts, to enable that all content is correctly displayed on the extended screen. For example, if the first terminal is a notebook computer, and the extended screen is a projector, the notebook computer may be connected to the projector through a projection or screen mirroring function of the notebook computer. When the presentation starts, a main screen (that is, a screen of the notebook computer) may display a note or a control interface of the presenter, and the extended screen (that is, a screen of the projector) displays presentation content.

In some embodiments, after transmitting the access information to the second terminal corresponding to the target audience, the first terminal may further transmit a synchronization request for the playback state to the second terminal in the process of controlling the playback state of the media file in the playback interface, to cause the second terminal to render, based on the synchronization request, state data that corresponds to the playback state and that is carried in the synchronization request, to synchronize the playback state of the media file.

In a process in which the presenter presents the target document (included in the process of controlling the playback state of the media file in the playback interface), the first terminal synchronizes a change of presentation data in the room interface at the presentation end to the audience end in real time through a synchronization request, to cause the audience end to synchronize with the presentation data of the room interface at the presentation end, to keep synchronization with the presentation data and page presentation at the presentation end.

In some embodiments, after transmitting the access information to the second terminal corresponding to the target audience, the first terminal may further receive an association establishment request transmitted by the second terminal, the association establishment request being configured for requesting to establish an association between a login account corresponding to the second terminal and the remote presentation room; and establish, in response to the association establishment request, the association between the login account corresponding to the second terminal and the remote presentation room when determining that the login account corresponding to the second terminal has access permission to the remote presentation room, the association being configured for the second terminal to synchronously update, when a presentation state of a target document presented in the remote presentation room is to be updated, the presentation state of the target document.

After the first terminal and the second terminal log in to or access the remote presentation room of the target document through browsers, the first terminal and the second terminal each establish a long link with the server. After transmitting the access information to the second terminal corresponding to the target audience, the first terminal may further receive an association establishment request transmitted by the second terminal. In response to the association establishment request, when determining that a login account corresponding to the second terminal has access permission to the remote presentation room (that is, has document viewing permission to the target document), the first terminal establishes an association between the login account corresponding to the second terminal and the remote presentation room. In this way, when a presentation state of the target document presented in the remote presentation room by the first terminal (that is, the presentation end) is updated, the second terminal (that is, the audience end) synchronously updates the presentation state of the target document, to keep synchronization with the presentation data and page presentation at the presentation end.

In the foregoing manner, when performing a remote presentation operation on a target document by accessing an application webpage link corresponding to a document presentation application, a presentation end (that is, a first terminal) generates access information of a remote presentation room corresponding to the target document and transmits the access information to a second terminal (that is, an audience end) corresponding to a target audience, to cause the second terminal to synchronize, after the second terminal accesses the remote presentation room based on the access information, a playback state of a media file when the first terminal controls the playback state of the media file based on a media control mechanism. In this way, the presentation end or the audience end can implement, when the media file in the target document is presented in a remote presentation scenario, synchronization between playback states of the media file at the presentation end and the audience end by accessing the application webpage link corresponding to the document presentation application (that is, accessing the webpage link corresponding to the document presentation application through the browser) without downloading an online document client, thereby improving convenience of remote presentation.

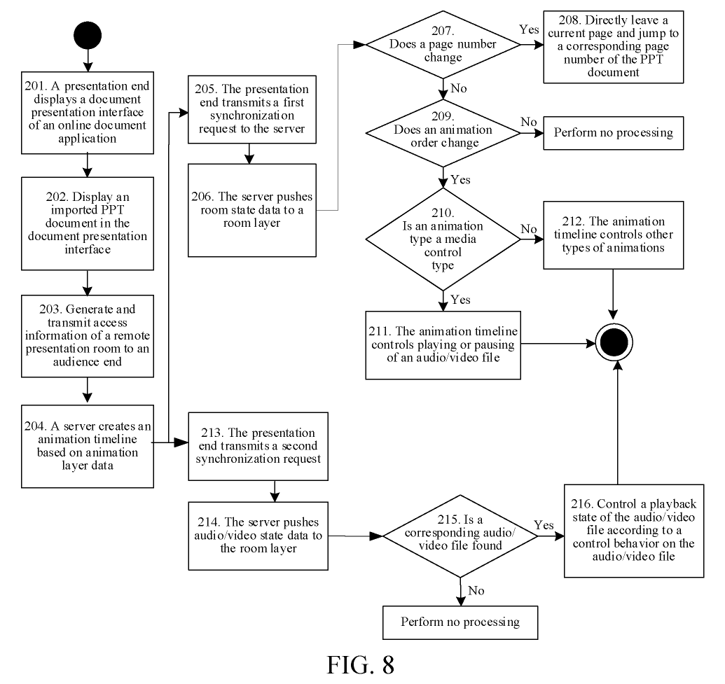

In some examples, when a remote presentation scenario corresponds to a web-end online document presentation scenario, and a target document is a PPT associated with a media file, many web-end online documents may support playing and pausing of an audio/video file (that is, the foregoing media file), but such control can only be implemented by directly interacting with a region (that is, an region in which a playback interface of the audio/video file is located) of the audio/video file. For example, FIG. 7 is a schematic diagram of web-end online document presentation according to an embodiment of this disclosure. When an audio/video file in a PPT is presented in a room interface, in (a), playing or pausing of the audio/video file can be controlled by only clicking/tapping a region of the audio/video file (that is, a playback interface 701 of the audio/video), while playing or pausing of the audio/video cannot be controlled by clicking/tapping a region in the room interface other than the playback interface 701; and in (b), playing or pausing of the audio/video can be controlled by only clicking/tapping a play button (that is, a play button 702 in the playback interface of the audio/video file) in a region of the audio/video file, while playing or pausing of the audio/video cannot be controlled by clicking/tapping another region in the playback interface other than the play button 702 or clicking/tapping another region in the room interface other than the playback interface. In addition, in an existing web-end online document presentation technology, synchronization of audio/video playback states at an audience end and a presentation end in a remote presentation scenario cannot be implemented.

Therefore, the embodiments of this disclosure provide a document presentation method. In a remote presentation scenario, when an audio/video file is presented, a presenter can freely trigger any region in a room interface of a remote presentation room (for example, any region in a room interface 703 shown in FIG. 7(c)) to control a playback state of the audio/video file, thereby expanding an interactive control region of the audio/video file to make user operations more convenient. In addition, in this disclosure, in the remote presentation scenario, the presenter can further perform presentation directly through a browser, and the audience can access the remote presentation room directly through a browser, so that synchronization of audio/video playback states the presentation end and at the audience end can be implemented, thereby improving the remote presentation experience.

FIG. 8 is a schematic flowchart of a document presentation method according to an embodiment of this disclosure. Description is provided with reference to the operations shown in FIG. 8.

Operation 201: A presentation end displays a document presentation interface of an online document application in response to an access operation for an application webpage link of the online document application.

The presentation end is the foregoing first terminal, the online document application is the foregoing document presentation application, and the application webpage link is a network address corresponding to the online document application, for example, may be represented as "https://docs.xx.com/". When a presenter logs in to and accesses the network address, the presentation end displays a document presentation interface of the online document application.

Operation 202: The presentation end displays an imported PPT document in the document presentation interface in response to a document import operation.

A document import control (e.g., a document import control element) is displayed in the document presentation interface. The presenter may import a PPT document (that is, the foregoing target document) as a to-be-presented document through the document import control. When the presenter triggers the document import control, the presentation end displays the imported PPT document in response to a document import operation triggered based on the document import control. An audio/video file is associated with the PPT document. In some examples, an imported document may be determined as the target document based on a document import operation on the document import control element.

After the presenter imports the PPT document, a server converts an XML file storing content of the PPT document into JSON data, and a PPT document that is successfully imported is displayed in a document list, that is, the imported PPT document is converted into an online document. The presenter accesses the online document through a browser. A front-end data layer converts the JSON data into SDK data layer data. A front-end service presentation layer converts the SDK data layer data into UI Model service presentation layer data for rendering and presentation. The UI Model service presentation layer data includes animation layer data (Animation Model). The animation layer data includes animation data corresponding to various animation types. The animation types include, but are not limited to: an entrance animation, an exit animation, an emphasis animation, and a media control animation. The media control animation is an animation type that can control playing and pausing of an audio/video file. An animation corresponding to the audio/video file is referred to as a media control animation.

Operation 203: The presentation end generates and transmits, in response to a remote presentation operation for the PPT document, access information of a remote presentation room to an audience end corresponding to a target audience.

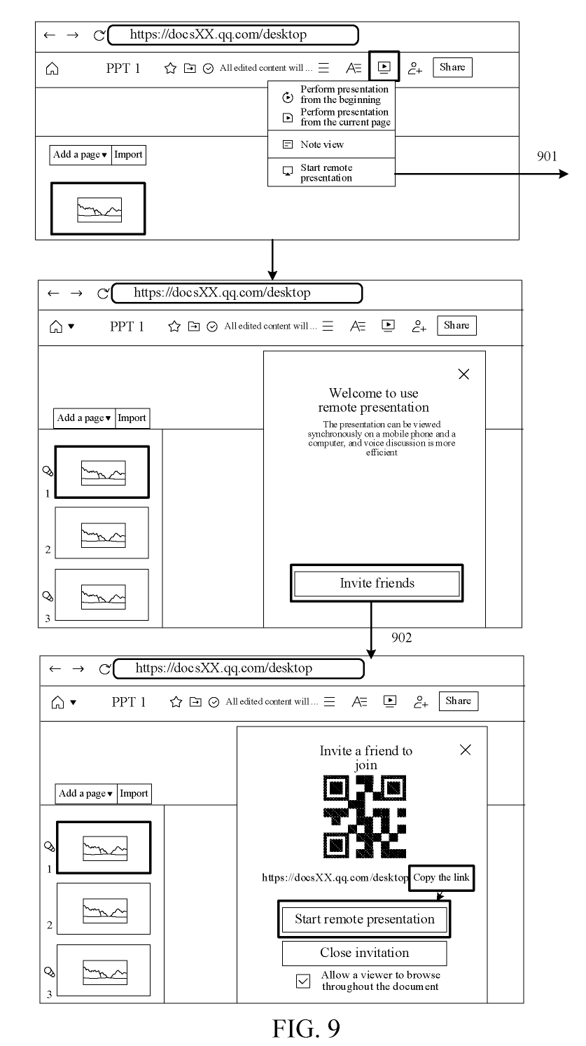

FIG. 9 is a schematic diagram of remote presentation according to an embodiment of this disclosure. A presenter may trigger a remote presentation operation by clicking/tapping a remote presentation control 901. In response to the remote presentation operation, a presentation end displays an invitation control (for example, Invite friends) 902 configured for inviting a friend (that is, an audience) to view presentation content. When the presenter clicks/taps the invitation control 902, the presentation end generates access information (for example, a link or a graphic barcode) of a remote presentation room layer in response to the click/tap operation. After the presenter distributes the access information to an audience end (that is, the foregoing second terminal), the presenter enters a remote presentation state, that is, displays a presented PPT document (for example, displays a first slide) in a room interface of the remote presentation room. The audience end enters the room layer by using the access information (for example, accessing the link or scanning the graphic barcode). The room layer implements bidirectional communication between a server and a terminal based on the WebSocket protocol.

Operation 204: The server creates an animation timeline based on animation layer data.

After entering the remote presentation room layer, the presenter and the audience create an animation timeline (that is, the foregoing presentation timeline) based on their respective animation layer data and with reference to a trigger condition and a trigger occasion of an animation. The animation timeline is configured for managing animation grouping of each slide and controlling an animation playback order. The media control animation is subject to management of the animation timeline, and unified management can be performed by the animation timeline on different types of animations.

Operation 205: The presentation end transmits a first synchronization request to the server in response to the presentation operation.

The presentation operation is triggered by the presenter clicking/tapping a slide page of a PPT document. For example, when the presenter clicks a current page, the presentation end first transmits a first synchronization request to the server by using the WebSocket protocol. The first synchronization request carries presentation room state data, and is configured for requesting synchronization of the presentation room state data. The presentation room state data (RoomStateData) is data (including data such as a page number of a slide and a playback order of an animation) that is generated by the presentation end according to the presentation operation performed by the presenter and is configured for controlling page turning and a playback order of an animation.

Operation 206: The server pushes room state data to the room layer in response to the first synchronization request.

After receiving the first synchronization request, in response to the first synchronization request, the server pushes latest room state data carried in the first synchronization request to the room layer.

Operation 207: The room layer determines whether a page number changes.

After the room layer receives the latest room state data, a front-end page is re-rendered, that is, the audience end synchronizes with the room state data at the presentation end, to keep synchronization with data and page presentation at the presentation end. All participants (including the presenter and the audience) in the room layer first determine whether page number data in the latest room state data changes. If the page number data changes, operation 208 is performed. If the page number data does not change, operation 209 is performed.

Operation 208: Directly leave a current page and jump to a corresponding page number of the PPT document.

Operation 209: Determine whether animation playback order data changes.

If the page number data does not change, it is then determined whether animation playback order data in the room state data changes. If the animation playback order data does not change, no processing is performed. If the animation playback order data changes, operation 210 is performed.

Operation 210: Determine whether an animation type is a media control type.

Animations are played in a corresponding order according to an animation timeline of a current page. When the animation timeline manages animation playback, an animation type is determined. Different animation types have different presentation forms. When the animation type is the media control type, operation 211 is performed. When the animation type is not the media control type, operation 212 is performed.

Operation 211: The animation timeline controls playing or pausing of an audio/video file.

Operation 212: The animation timeline controls other types of animations.

Operation 213: The presentation end transmits a second synchronization request to the server in response to a trigger operation for a region of the audio/video file.

When the presenter directly operates a region of the audio/video file, for example, performs an operation such as fast forward, rewind, play, or pause (that is, a playback rhythm of the audio/video file is controlled by triggering a control that the playback interface of the media file itself has), the presentation end transmits a second synchronization request to the server by using the WebSocket protocol. The second synchronization request carries audio/video state data, and is configured for requesting synchronization of the audio/video state data. The audio/video state data (RoomMediaData) is generated by the presentation end according to a trigger operation performed by the presenter for the region of the audio/video file, includes a control behavior, a playback time, an audio/video identifier, a playback doubling speed, and the like, and is configured for controlling playing, pausing, or fast forwarding of the audio/video file.

Operation 214: The server pushes the audio/video state data to the room layer in response to the second synchronization request.

After receiving the second synchronization request, the server pushes the latest audio/video state data to the room layer in response to the second synchronization request.

Operation 215: The room layer determines whether a corresponding audio/video file is found.

The room layer receives the latest audio/video data, and the front-end page is re-rendered. That is, the audience end synchronizes the audio/video data at the presentation end, to keep synchronization with the audio/video data and audio/video playback at the presentation end. All participants (including the presenter and the audience) in the room level first determine whether an audio/video file in the latest audio/video data is found. If the audio/video file is not found, no processing is performed. If the audio/video file is found, operation 216 is performed.

Operation 216: Control a playback state of the audio/video file according to a control behavior on the audio/video file.

When the audio/video file is presented, the presenter can freely trigger any region in a room interface of a remote presentation room to control a playback state of the audio/video file, for example, control playing, pausing, fast forwarding, or rewinding of the audio/video file, thereby expanding an interactive control region of the audio/video file to make user operations more convenient.

In the foregoing manner, the embodiments of this disclosure have at least the following beneficial effects: (1) Shortcomings of controlling audio/video playback in a web-end online document are addressed, playing and pausing of an audio/video file can be controlled in a form of an animation, and an audio/video interactive region is expanded, so that user operations are more convenient and the experience is more friendly. 2) Unified management is performed on a media control animation (controlling playing and pausing of an audio/video file) and other types of animations (such as an entrance animation, an exit animation, and an emphasis animation) through an animation timeline, which supports that different types of animations can be sequentially played after being combined. 3) In a remote presentation scenario, synchronization between a media control animation and an audio/video operation behavior is implemented, so that audio/video playback states of an audience and a presenter are maintained consistent.

In some embodiments, a document presentation apparatus 555 provided in this disclosure includes various modules cooperating to implement a document presentation solution.

A first display module 5551 is configured to display a document presentation interface of a document presentation application in response to an access operation for an application webpage link of the document presentation application. A second display module 5552 is configured to display a target document associated with a media file in the document presentation interface, the media file having a media control mechanism preset for controlling a playback state of the media file. A third display module 5553 is configured to generate and display access information of a remote presentation room corresponding to the target document in response to a remote presentation operation for the target document. An information transmitting module 5554 is configured to transmit the access information to a second terminal corresponding to a target audience, to cause the second terminal to synchronize, after the second terminal accesses the remote presentation room based on the access information, the playback state of the media file when the first terminal controls the playback state of the media file based on the media control mechanism.

In some embodiments, the second display module is further configured to display a document import control in the document presentation interface; and display, in response to a document import operation triggered based on the document import control, the imported target document associated with the media file.

In some embodiments, the third display module is further configured to: obtain a room identifier of the remote presentation room, and generating a room webpage link corresponding to the remote presentation room based on the room identifier and the application webpage link; and display the room webpage link as the access information, or displaying, as the access information, a graphic barcode obtained by encoding the room webpage link.

In some embodiments, the information transmitting module is configured to transmit the access information to the second terminal corresponding to the target audience in a target mode, the target mode including at least one of the following: an instant messaging mode, an email mode, a short message mode, or a call notification mode.

In some embodiments, after transmitting the access information to the second terminal corresponding to the target audience, the apparatus further includes: a presentation processing module, configured to display presentation content of the target document in a room interface of the remote presentation room; display, in the process of displaying the presentation content of the target document, a playback interface of the media file in the room interface in response to that a presentation occasion of the media file arrives; and control the playback state of the media file in the playback interface in response to a state control instruction triggered based on the media control mechanism.

In some embodiments, before displaying the playback interface of the media file in the room interface, the apparatus further includes: a presentation occasion determining module, configured to determine, in response to presenting a target page of the media file in the target document and presentation duration of the target page reaches target duration, that the presentation occasion of the media file arrives; or display, in response to presenting a target page of the media file in the target document, a presentation control of the media file in the target page, and determining, in response to a trigger operation for the presentation control, that the presentation occasion of the media file arrives; or display, in response to presenting a target page of the media file in the target document, presentation prompt information corresponding to the media file at a display position associated with the media file in the target page, and determining, in response to a determining operation for the presentation prompt information, that the presentation occasion of the media file arrives.

In some embodiments, the presentation processing module is further configured to display the playback interface of the media file through a sub-interface independent of the room interface; or present, in a target animation presentation mode, a process in which the playback interface of the media file moves to a target region of the room interface.

In some embodiments, the presentation processing module is further configured to: control, when the media control mechanism is a position-triggered mechanism, in response to a first state control instruction triggered based on a first position, the media file to start playing in the playback interface; and control, in a process of playing the media file in the playback interface, in response to a second state control instruction triggered based on a second position, the media file to stop playing in the playback interface, the playback interface being a sub-interface of the room interface, and the first position and the second position each including at least one of the following positions: any position in another sub-interface in the room interface other than the playback interface and any position in the playback interface.

In some embodiments, the presentation processing module is further configured to accelerate a playback progress of the media file in response to a trigger operation for a fast forward control in the playback interface in the process of playing the media file in the playback interface; and rewind a playback progress of the media file in response to a trigger operation for a rewind control in the playback interface.

In some embodiments, the presentation processing module is further configured to: obtain, when the media control mechanism is an element-triggered mechanism, a target trigger element associated with the element-triggered mechanism, the target trigger element being any one or more trigger elements in the room interface; and control the playback state of the media file in the playback interface in response to a state control instruction triggered based on the target trigger element.

In some embodiments, the presentation processing module is further configured to output media content of the media file through the playback interface when the playback state indicates that the media file is being played; display, in response to a presentation operation for another part in the target document other than the media file, presentation content of the another part in the room interface other than the media file in the process of outputting the media content; and adjust a parameter of the playback interface in the process of displaying the presentation content of the another part, and continue outputting the media content through the playback interface corresponding to the adjusted parameter, the parameter including at least one of the following: a size of the playback interface, a position of the playback interface, transparency of the playback interface, and a volume at which audio content is outputted through the playback interface.

In some embodiments, when the target document includes target content associated with an animated presentation effect, the apparatus further includes: a motion effect presentation module, configured to present, in the process of displaying the presentation content of the target document, the target content in a presentation style corresponding to the animated presentation effect in response to that a presentation occasion of the target content arrives.

In some embodiments, the apparatus further includes: a presentation occasion processing module, configured to create, based on the presentation occasion of the media file and the presentation occasion of the target content, a presentation timeline configured for controlling a presentation order of the media file and the target content; and determine, based on the presentation timeline, whether the presentation occasions of the media file and the target content arrive.

In some embodiments, the presentation processing module is further configured to: control, in response to a document presentation operation triggered through a control device, presentation of another part in the target document other than the media file according to a presentation rhythm indicated by the document presentation operation, and synchronously display presentation content of the another part, the control device including at least one of the following: a keyboard, a mouse, a remote control, and a virtual keyboard in a presentation extended screen.

In some embodiments, after transmitting the access information to the second terminal corresponding to the target audience, the apparatus further includes: a synchronization transmitting module, configured to transmit a synchronization request for the playback state to the second terminal in the process of controlling the playback state of the media file in the playback interface, to cause the second terminal to render, based on the synchronization request, state data that corresponds to the playback state and that is carried in the synchronization request, to synchronize the playback state of the media file. In some examples, the synchronization request may be configured to enable the second terminal to render the presentation of the target document at the second terminal in synchronization with the playback state of the media file indicated by the synchronization request.

In some embodiments, after the transmitting the access information to the second terminal corresponding to the target audience, the apparatus further includes: an association establishing module, configured to: receive an association establishment request transmitted by the second terminal, the association establishment request being configured for requesting to establish an association between a login account corresponding to the second terminal and the remote presentation room; and establish, in response to the association establishment request, the association between the login account corresponding to the second terminal and the remote presentation room when determining that the login account corresponding to the second terminal has access permission to the remote presentation room, the association being configured for the second terminal to synchronously update, when a presentation state of a target document presented in the remote presentation room is to be updated, the presentation state of the target document.

The embodiments of this disclosure provide a computer program product, including a computer program or computer-executable instructions, the computer program or the computer-executable instructions being stored in a non-transitory computer-readable storage medium. Processing circuitry (e.g., a processor) of an electronic device reads the computer-executable instruction from the non-transitory computer-readable storage medium, and the processor executes the computer-executable instruction to cause the electronic device to perform the document presentation method according to the embodiments of this disclosure.

The embodiments of this disclosure provide a non-transitory computer-readable storage medium, having computer-executable instructions or a computer program stored therein, the computer-executable instructions or the computer program, when executed by processing circuitry (e.g., a processor), causing the processor to perform the document presentation method provided in the embodiments of this disclosure, for example, the document presentation method shown in FIG. 3.

In some embodiments, the non-transitory computer-readable storage medium may be a memory such as a FRAM, a ROM, a PROM, an EPROM, an EEPROM, a flash memory, a magnetic surface memory, an optical disk, or a CD-ROM, or may be various devices including one or any combination of the foregoing memories.

In some embodiments, the computer-executable instructions may be written in any form of programming language (including a compiled or interpreted language, or a declarative or procedural language) by using the form of a program, software, a software module, a script or code, and may be deployed in any form, including being deployed as an independent program or being deployed as a module, a component, a subroutine, or another unit suitable for use in a computing environment.

In an example, the computer-executable instructions may, but do not necessarily, correspond to a file in a file system, and may be stored in a part of a file that saves another program or other data, for example, be stored in one or more scripts in a hypertext markup language (HTML) file, stored in a file that is specially configured for a program in discussion, or stored in the plurality of collaborative files (for example, be stored in files of one or modules, subprograms, or code parts).

In an example, the computer-executable instructions may be deployed for execution on one electronic device, execution on a plurality of electronic devices located at one position, or execution on a plurality of electronic devices that are distributed at a plurality of positions and that are interconnected through a communication network.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing descriptions are merely non-limiting embodiments of this disclosure and are not intended to limit the scope of this disclosure. Any modification, equivalent replacement, or improvement made without departing from the spirit and range of this disclosure shall fall within the scope of this disclosure.

What is claimed is:

1. A document presentation method, the method comprising:
displaying, on a display of a first terminal, a document presentation interface of a document presentation application based on accessing an application webpage link of the document presentation application;
determining a target document based on a selection operation on the document presentation interface, the target document including a media file controllable through a media control mechanism;
generating access information of a remote presentation room of the document presentation application corresponding to a presentation of the target document based on a remote presentation operation for the target document;
transmitting the access information to a second terminal corresponding to a target audience of the presentation, the access information enabling the second terminal to access the remote presentation room, from which the presentation of the target document in a room interface of the remote presentation room is observable to the second terminal when the presentation is controlled through the room interface of the remote presentation room;
displaying presentation content of the target document in the room interface of the remote presentation room;
displaying a playback interface of the media file in the room interface; and
controlling a playback state of the media file in the playback interface through the media control mechanism based on at least one or more playback control operations triggered in association with one or more positions or elements in the room interface irrespective of whether the one or more positions or elements are in the playback interface.

2. The method according to claim 1, wherein the determining the target document comprises:
displaying a document import control element in the document presentation interface; and
determining an imported document as the target document based on a document import operation on the document import control element.

3. The method according to claim 1, wherein
the generating the access information comprises:
obtaining a room identifier of the remote presentation room; and
obtaining a room webpage link corresponding to the remote presentation room based on the room identifier and the application webpage link, and
the access information includes the room webpage link or a graphic barcode obtained by encoding the room webpage link.

4. The method according to claim 1, wherein
the access information is transmitted to the second terminal when the second terminal is in a target mode, and
the target mode includes at least one of an instant messaging mode, an email mode, a short message mode, or a call notification mode.

5. The method according to claim 1, further comprising:
determining, based on presenting a target page of the media file in the target document and a presentation duration of the target page reaching a target duration, that a presentation occasion of the media file arrives; or
displaying, based on presenting the target page of the media file in the target document, a presentation control element of the media file in the target page, and determining, based on a trigger operation of the presentation control element, that the presentation occasion of the media file arrives; or
displaying, based on presenting the target page of the media file in the target document, presentation prompt information corresponding to the media file at a display position associated with the media file in the target page, and determining, based on a determining operation on the presentation prompt information, that the presentation occasion of the media file arrives.

6. The method according to claim 1, wherein the displaying the playback interface comprises:
displaying the playback interface of the media file through a sub-interface independent of the room interface; or
presenting, in a target animation presentation mode, a process in which the playback interface of the media file moves to a target region of the room interface.

7. The method according to claim 1, wherein
the controlling the playback state comprises:
controlling, when the media control mechanism is a position-triggered mechanism, and when a first state control instruction is triggered based on a first position, the media file to start playing in the playback interface; and
controlling, in a process of playing the media file in the playback interface, when a second state control instruction is triggered based on a second position, the media file to stop playing in the playback interface,
the playback interface is a sub-interface of the room interface, and
the first position and the second position each includes at least one of any position in another sub-interface in the room interface other than the playback interface or any position in the playback interface.

8. The method according to claim 1, further comprising:
accelerating a playback progress of the media file based on a trigger operation for a fast forward control element in the playback interface in a process of playing the media file in the playback interface; and
rewinding the playback progress of the media file based on a trigger operation for a rewind control element in the playback interface.

9. The method according to claim 1, wherein the controlling the playback state comprises:
obtaining, when the media control mechanism is an element-triggered mechanism, a target trigger element associated with the element-triggered mechanism, the target trigger element being any one or more trigger elements in the room interface; and
controlling the playback state of the media file in the playback interface when a state control instruction is triggered based on the target trigger element.

10. The method according to claim 1, further comprising:
outputting media content of the media file through the playback interface when the playback state indicates that the media file is being played;
displaying, based on a presentation operation for another part in the target document other than the media file, presentation content of the another part in the room interface other than the media file in a process of outputting the media content;
adjusting a parameter of the playback interface in a process of displaying the presentation content of the another part; and
continuing outputting the media content through the playback interface corresponding to the adjusted parameter, wherein
the parameter includes at least one of a size of the playback interface, a position of the playback interface, transparency of the playback interface, or a volume at which audio content is outputted through the playback interface.

11. The method according to claim 1, wherein
the target document includes target content associated with an animated presentation effect, and
the method includes:
presenting, in a process of the presentation of the target document, the target content in a presentation style corresponding to the animated presentation effect when a presentation occasion of the target content arrives.

12. The method according to claim 11, further comprising:
creating, based on a presentation occasion of the media file and the presentation occasion of the target content, a presentation timeline indicating a presentation order of the media file and the target content; and
determining, based on the presentation timeline, whether the presentation occasions of the media file and the target content arrive.

13. The method according to claim 1, wherein
the presentation of the target document is controllable based on a document presentation operation triggered through a control device, and
the control device includes at least one of a keyboard, a mouse, a remote control, or a virtual keyboard in a presentation extended screen.

14. The method according to claim 1, further comprising:
transmitting a synchronization request for the playback state to the second terminal in a process of controlling the playback state of the media file in the playback interface,
the synchronization request being configured to enable the second terminal to render the presentation of the target document at the second terminal in synchronization with the playback state of the media file indicated by the synchronization request.

15. The method according to claim 1, further comprising:
receiving an association establishment request from the second terminal, the association establishment request indicating a request to establish an association between a login account corresponding to the second terminal and the remote presentation room; and
establishing, based on the association establishment request, the association between the login account corresponding to the second terminal and the remote presentation room when the login account corresponding to the second terminal is determined to have access permission to the remote presentation room.

16. A document presentation apparatus, comprising:
processing circuitry configured to:
display, on a display, a document presentation interface of a document presentation application based on access of an application webpage link of the document presentation application;
determine a target document based on a selection operation on the document presentation interface, the target document including a media file controllable through a media control mechanism;
generate access information of a remote presentation room of the document presentation application corresponding to a presentation of the target document based on a remote presentation operation for the target document;
transmit the access information to a terminal corresponding to a target audience of the presentation, the access information enabling the terminal to access the remote presentation room, from which the presentation of the target document in a room interface of the remote presentation room is observable to the terminal when the presentation is controlled through the room interface of the remote presentation room;
display presentation content of the target document in the room interface of the remote presentation room;
display a playback interface of the media file in the room interface; and
control a playback state of the media file in the playback interface through the media control mechanism based on at least one or more playback control operations triggered in association with one or more positions or elements in the room interface irrespective of whether the one or more positions or elements are in the playback interface.

17. The apparatus according to claim 16, wherein
the processing circuitry is configured to:
obtain a room identifier of the remote presentation room; and
obtain a room webpage link corresponding to the remote presentation room based on the room identifier and the application webpage link, and
the access information includes the room webpage link or a graphic barcode obtained by encoding the room webpage link.

18. The apparatus according to claim 16, wherein
the processing circuitry is configured to:
control, when the media control mechanism is a position-triggered mechanism, and when a first state control instruction is triggered based on a first position, the media file to start playing in the playback interface; and
control, in a process of playing the media file in the playback interface, when a second state control instruction is triggered based on a second position, the media file to stop playing in the playback interface,
the playback interface is a sub-interface of the room interface, and
the first position and the second position each includes at least one of any position in another sub-interface in the room interface other than the playback interface or any position in the playback interface.

19. The apparatus according to claim 16, wherein the processing circuitry is configured to:
obtain, when the media control mechanism is an element-triggered mechanism, a target trigger element associated with the element-triggered mechanism, the target trigger element being any one or more trigger elements in the room interface; and
control the playback state of the media file in the playback interface when a state control instruction is triggered based on the target trigger element.

20. A non-transitory computer-readable storage medium storing instructions, which when executed by a processor, cause the processor to perform a document presentation method comprising:
displaying, on a display, a document presentation interface of a document presentation application based on accessing an application webpage link of the document presentation application;
determining a target document based on a selection operation on the document presentation interface, the target document including a media file controllable through a media control mechanism;
generating access information of a remote presentation room of the document presentation application corresponding to a presentation of the target document based on a remote presentation operation for the target document;
transmitting the access information to a terminal corresponding to a target audience of the presentation, the access information enabling the terminal to access the remote presentation room, from which the presentation of the target document in a room interface of the remote presentation room is observable to the terminal when the presentation is controlled through the room interface of the remote presentation room;
displaying presentation content of the target document in the room interface of the remote presentation room;
displaying a playback interface of the media file in the room interface; and
controlling a playback state of the media file in the playback interface through the media control mechanism based on at least one or more playback control operations triggered in association with one or more positions or elements in the room interface irrespective of whether the one or more positions or elements are in the playback interface.
